(19) United States
(12) Patent Application Publication
(10) Pub. No.: US 2014/0172460 A1
(43) Pub. Date: Jun. 19, 2014

(54) System, Method, and Computer Program Product for Digitally Recorded Musculoskeletal Diagnosis and Treatment

(71) Applicant: Navjot Kohli, Milwaukee, WI (US)

(72) Inventor: Navjot Kohli, Milwaukee, WI (US)

(21) Appl. No.: 14/133,430

(22) Filed: Dec. 18, 2013

Related U.S. Application Data
(60) Provisional application No. 61/739,670, filed on Dec. 19, 2012.

(51) Int. Cl. G06F 19/00

(52) U.S. Cl. CPC G06F 19/3481; G06F 19/321
USPC 705/3

(57) ABSTRACT

A system, method, and computer program product to assist a clinician in diagnosing or treating a musculoskeletal condition of a patient.

### CROSS-REFERENCE TO RELATED APPLICATION

This application claims the benefit of U.S. Provisional Application No. 61/739670 filed Dec. 19, 2012, the disclosure of which is incorporated by reference.

### FIELD OF THE INVENTION

The present invention relates to a system, method, and computer program product for use with electronic computing and imaging devices to assist a clinician in diagnosing a musculoskeletal disorder, and subsequently guiding an individual in conducting physical therapy.

### BACKGROUND OF THE INVENTION

One of the primary concerns of medical clinics is operating costs, which are directly impacted by the efficiency of the clinical staff. Having a clinician physically evaluate an individual, such as one who is conducting range of motion tests on an afflicted joint, is an inefficient use of the clinician's time. The evaluation may also be subjective in that it is based on the clinician's eyeball measurement of the patient's movement.

Likewise, physical therapy is an enormous health care expenditure. Physical therapy is used in orthopedics after trauma, joint replacements, rotator cuff repairs, soft tissue injuries, etc. It is used in other specialties after strokes, cardiac care, and major surgeries. It is a multibillion dollar industry.

For orthopedics, and other specialties as well, many physical therapy exercises can be done at home. The value from a physical therapist is education—he/she can teach the patient what exercises to do, when it is appropriate to do those exercises, and most importantly how to do them.

The system, method, and computer program product of the present disclosure reduces costs in clinician's time by automating large portions of the physical exam and physical therapy sessions to free the clinician from data collection, so that s/he may concentrate on medical decision making.

The system, method, and computer program product of the present disclosure also permits the patient to conduct physical therapy in the privacy of their home, and provide a copy of a video of the patient conducting the physical therapy exercises to their clinician via the Internet. Therefore, patients who live at remote locations or have difficulty commuting to a clinician's office, may be more compliant with prescribed treatments.

### SUMMARY OF THE INVENTION

The present disclosure provides a system, method, and computer program product to assist a clinician in diagnosing a musculoskeletal condition of a patient, and/or guide the patient through rehabilitative exercises which can be performed and digitally recorded in the absence of a clinician. The videotaped sessions may be electronically transmitted to and stored within a patient's record on a system server for the clinician to evaluate and provide feedback to the patient.

In one aspect, the present disclosure provides a computer program product. By way of example, the computer program product of the present disclosure, when executed on a computer, may: provide standard diagnostic and rehabilitative exercises that may be demonstrated by a computer generated human image (e.g. an avatar); provide an audio voice to instruct the patient on how to do the exercises and inform the patient as to whether he/she is performing the exercises correctly; instruct the patient to perform the procedure a number of times; count the number of times the exercise has been performed; and/or indicate to the patient when he or she has not completed all of the required repetitions.

In one embodiment, the computer program product of the present disclosure comprises a computer useable medium and computer readable program code stored on the computer useable medium, which, when the computer readable program code is executed on a computer, performs a method for assisting a clinician in diagnosing or treating a musculoskeletal condition of a patient, the method comprising: capturing an image of a patient's movement of one or more musculoskeletal joints and appendages while the patient is performing a diagnostic or rehabilitation exercise; transmitting the image of the patient performing the exercise to a clinician; receiving the image of the patient performing the exercise; displaying the image of the patient performing the exercise; recording comments by a clinician on the patient's performance of the exercise; storing the image and comments in the patient's record in a database; and providing the patient access to the patient record.

In some embodiments, the computer program product further comprises computer readable program code stored on the computer useable medium, which, when the computer readable program code is executed on a computer, converts the imaging data into a range of motion in degrees of the musculoskeletal joints and appendages depicted in the image; and stores the range of motion data in the patient record.

In one aspect, the present disclosure provides a method in a computer system for assisting a clinician in diagnosing or treating a musculoskeletal condition of a patient, the method comprising: capturing an image of a patient's movement of one or more musculoskeletal joints and appendages while the patient is performing a diagnostic or rehabilitation exercise; transmitting the image of the patient performing the exercise to a clinician; receiving the image of the patient performing the exercise; displaying the image of the patient performing the exercise; recording comments by a clinician on the patient's performance of the exercise; storing the image and comments in the patient's record in a database; and providing the patient access to the patient record.

In some embodiments, the method further comprises converting the imaging data into a range of motion in degrees of the musculoskeletal joints and appendages depicted in the image;

and stores the range of motion data in the patient record.

In some embodiments, the method comprises: 1) imaging and calculating a patient's movement (e.g. range of motion of musculoskeletal joints and appendages); 2) digitally recording a clinician's verbally stated findings during a physical exam of the patient; 3) storing (1) and (2) within a patient's record on a database; and 4) providing the patient a copy of the record, comprising either a hardcopy, a website link, or access to part of a patient record on a system server database.

By way of example, a clinician (e.g. physician, physical therapist, nurse, etc.) using the system, method, and computer program product of the present disclosure may: 1) create a patient record with a patient history, e.g. pre and post operation treatment, on a system server; 2) select rehabilitation exercises and/or create custom exercises for the patient specific to their medical condition; 3) monitor and provide feedback to the patient upon reviewing their recorded exercise sessions; and 4) store all electronic communications (e.g. feedback) and recorded sessions within the patient's records on the system server.

By way of further example, if a patient is conducting rehabilitation exercises outside of a clinician setting, such as in the privacy of their home, the patient, using the system, method, and computer program product of the present disclosure, may: 1) download or access a copy of the computer program product onto their electronic computing device (e.g. laptop); 2) download or access a copy of their clinician designated exercise program; 3) perform the exercises by following the images projected onto an electronic display device (e.g. large screen TV monitor) while the session is being recorded by an imaging device; 4) provide a copy of the exercise session to the clinician, e.g. electronically transmitting to their clinician's office, and/or uploading a copy to their patient record on the system server; and 5) receive feedback from the clinician who has reviewed their exercise sessions. The imaging device can be, for example, an Xbox® Kinect® from Microsoft Corporation, Redmond, Wash., or similar device.

The feedback may be in person, such as for a patient who performs the exercise session in a clinical setting, but in the absence of the clinician; or it may be via electronic communications (e.g. VoIP conference call); or it may be via the patient reviewing an video/audio file accessible via an electronic communication (e.g. email attachment), or stored within their patient record file on the system server and accessible via a website link, or other methods well known in the art of electronic communications and website services.

In addition to the feedback comprising clinician's instructions on the proper performance of the exercises, the feedback may comprise various aspects of patient/clinician communications, such as appointments, and other treatment information (e.g. prescription information, pre/post operation protocols, etc.).

The present disclosure further comprises modules for enabling social networking with other individuals undergoing similar therapies, as well as gamification through the social network and through therapy specific benchmarks.

### BRIEF DESCRIPTION OF THE DRAWINGS

The foregoing aspects and many of the advantages of this invention will become more readily appreciated and better understood by reference to the following detailed description, when taken in conjunction with the accompanying drawings, wherein:

FIG. 1 comprises a schematic diagram of the system architecture for the clinician's office and/or patient's home in utilizing the software and hardware to setup, record, and review patient exercise sessions.

FIG. 2 comprises a schematic diagram of the system architecture for the website service and system database for clinicians and patients to access the computer program product and the patients' records.

FIG. 3A is a screen shot of the homepage showing the options for diagnostic and rehabilitation exercise selection for a new or existing patient.

FIG. 3B is a flowchart of steps in using the computer program product by a clinician to create a patient account for diagnosis and treatment, select exercises, review a history of a patient's exercise sessions, and provide a patient feedback and further instructions.

FIGS. 4A-4E are screen shots for creating a customized session. FIG. 4A is a screen shot of the “Select Workout” feature for a shoulder injury; FIG. 4B is the “Customize Session” screen; FIG. 4C is the “Load Customize Session” screen shot; FIG. 4D is the “Select Exercise” screen shot; and FIG. 4E is a “Rotation” shoulder exercise screen shot.

FIG. 5 is a screen shot for creating a new patient record on the system server database.

FIG. 6 is a screen shot of an exemplification of the images the patient will see on a TV screen when performing the exercise with the present system: the avatar in the middle is the patient's computer generated image, the avatar on the right is the tutor, and the image in the top right is the patient's camera image.

FIG. 7 is a screen shot of the image generated on the electronic display device (e.g.TV screen) prior to the patient exercising and while the avatar is demonstrating how to properly perform the exercise.

FIG. 8 is a screen shot of the image generated on the electronic display device (e.g.TV screen) while the patient is exercising with the avatar.

FIG. 9 is a screen shot of the “History Video” page that the clinician reviews to watch and comment on the patient's exercise sessions.

FIG. 10 is a screen shot of the “History Graph” generated by the system displaying the range of motion achieved by the patient during the recorded exercise session on a particular day.

### DETAILED DESCRIPTION

### Glossary of Terms

Unless specifically defined herein, all terms used herein have the same meaning as they would to one skilled in the art of the present invention.

As used herein, the term “user” refers to a clinician (e.g. medical doctor, physical therapist, or assistant) who utilizes the computer program product of the present disclosure to create patient files, select and/or customize the exercise programs for patient rehabilitation, review videos of patient recorded exercise sessions stored on a system database, and provide messages electronically transmitted to the patient comprising feedback, treatment instructions, etc. The term “User” may also refer to a patient who practices the exercise sessions and saves video recordings of the exercise sessions to their file on the system server via a network connection.

As used herein, the term “electronic computing device” refers to a “user's” computing device, which comprises any electronic device with the ability to transmit and receive electronic communications via a network (e.g. the Internet) and comprising a central processing unit (i.e. processor) with the ability to execute the modules/software of the present disclosure, such as laptops, tablets, desktops and smartphones. The devices also have the ability, when used in conjunction with the computer program product of the present invention, as well as software associated with a particular imaging device, to receive imaging data from an electronic sensing and imaging device, to convert the imaging data into ranges of motion in degrees, and to electronically transmit (e.g. wirelessly) data to an electronic display device.

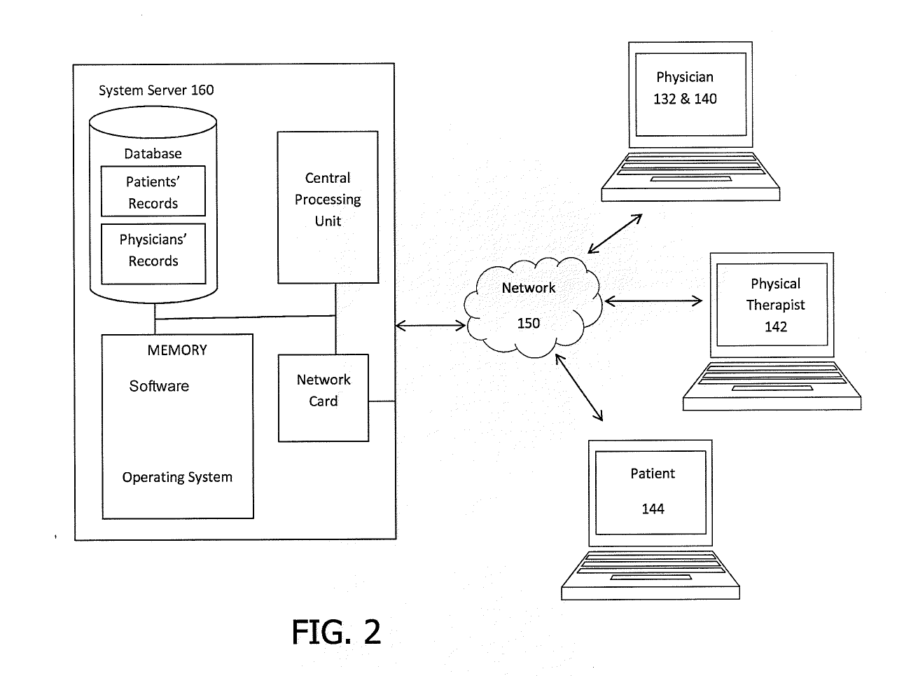

As used herein, the term “system” refers to the entire configuration of hardware and software in all embodiments. In one embodiment as illustrated in FIG. 2, the “system” comprises a client-server architecture with a system server, wherein the system server comprises a central processing unit, database of patient records, network connection, etc.; an electronic computing device with Internet connectivity communicating with the system server (e.g. for downloading or accessing the computer program product from the system server); an electronic sensing and imaging device to capture a patient's movement while exercising; and, an electronic display device to display the images generated by the computer program product using the data from the imaging device.

In one embodiment of the present disclosure, the user's or client electronic computing device functions as the system server by storing all patient data and transmitting patient records and video via established electronic communications means (e.g. email attachment of video).

As used herein, the term “software” refers to computer program instructions adapted for execution by a hardware element, such as a processor, wherein the instructions comprise commands that when executed cause the processor(s) to perform a corresponding set of commands. The software may be written or coded using a programming language, and stored using any type of non-transitory computer-readable media or machine-readable media well known in the art. Examples of software in the present disclosure comprise any software components, programs, applications, computer programs, application programs, system programs, machine programs, and operating system software.

As used herein, the term “module” refers to a portion of a computer program or software or algorithm that carries out a specific function for assisting in patient rehabilitation, and may be used alone or combined with other modules of the same program.

In one aspect, the present disclosure provides a method in a computer system for assisting a clinician in diagnosing or treating a musculoskeletal condition of a patient, the method comprising: capturing an image of a patient's movement of one or more musculoskeletal joints and appendages while the patient is performing a diagnostic or rehabilitation exercise; transmitting the image of the patient performing the exercise to a clinician; receiving the image of the patient performing the exercise; displaying the image of the patient performing the exercise; recording comments by a clinician on the patient's performance of the exercise; storing the image and comments in the patient's record in a database; and providing the patient access to the patient record.

In some embodiments, the method further comprises converting the imaging data into a range of motion in degrees of the musculoskeletal joints and appendages depicted in the image; and stores the range of motion data in the patient record.

In one aspect, the present disclosure provides a computer system for assisting a clinician in diagnosing or treating a musculoskeletal condition of a patient, comprising: an imaging component that captures an image of a patient's movement of one or more musculoskeletal joints and appendages; a transmission component that transmits the image to a clinician; and a receiving component that receives the image; a display component that displays the image; a recording component that records the clinician's verbal comments regarding the image; and a storage component that stores the image and comments in a patient record. In some embodiments, the computer system further comprises a conversion component that converts the imaging data into a range of motion in degrees of the musculoskeletal joints and appendages depicted in the image. The computer system of the present disclosure is further described below.

System Architecture

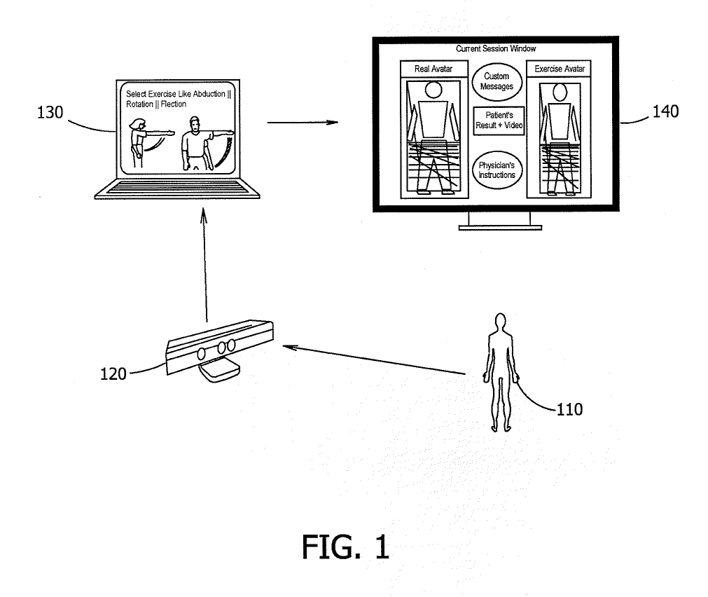

As illustrated in FIG. 1, the primary system components utilized by patient 110 may include: an electronic sensing and imaging device 120 for capturing and recording the patient's movements; an electronic computing device 130 for receiving the imaging data and converting the data into ranges of motion, amongst other calculations; and an electronic display device 140 for displaying the computer generated images from device 130 for the user to view in real-time, or from a pre-recorded video. In some embodiments, the devices communicate via wireless means.

The sensing and imaging device 120 comprises hardware and software to detect and record the movement of each of the patient's musculoskeletal joints, and to transmit the data to the electronic computing device 130 that converts the raw data into ranges of motion in degrees. In an exemplary embodiment, the sensing and imaging device comprises: 1) a capture device comprising an image camera with a depth camera, an IR light component, a three-dimensional (3-D) camera, and/or an RGB camera that may be used to capture the depth image of a scene; 2) a microphone comprising a transducer or sensor that may receive and convert sound into an electrical signal to receive audio signals such as of the clinician when stating his/her diagnostic findings; 3) a processor in operative communication with the image camera component that may execute instructions such as for receiving the depth image, determining whether a suitable target may be included in the depth image, converting the suitable target into a skeletal representation or model of the target; 4) a memory component storing the instructions executed by the processor, images or frames of images captured by the 3-D camera or RGB camera, or any other suitable information, and images, and 5) a means of transmitting the stored data and images to the electronic computing device 130 (e.g. wireless electronic components). An example of a sensing and imaging device 120 suitable for use in the present disclosure is an Xbox® Kinect®. Other similar imaging devices may be used.

The system component of the present disclosure that converts data provided by the image device into ranges of motion may be located on the patient's computing device or on the clinician's computing device. The images and/or range of motion data may be displayed on the screen of the electronic display device (e.g. TV) 140.

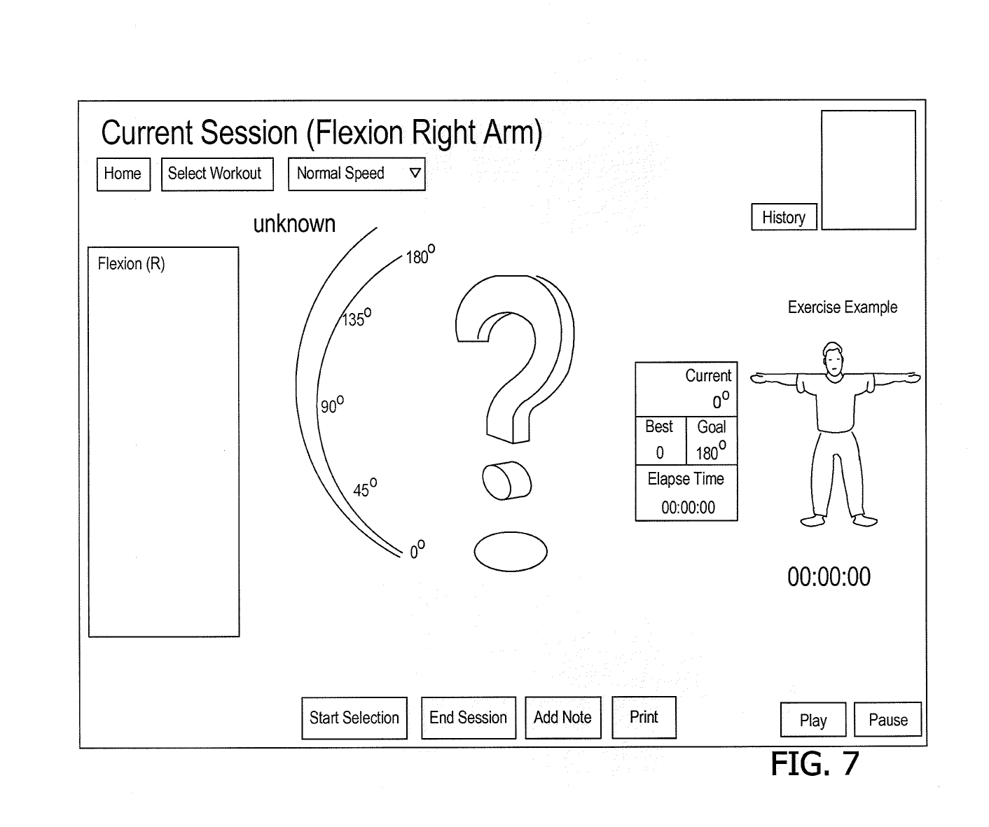

FIG. 7 provides an illustration of an exemplification of the image the patient may see on the screen of device 140 when the system is providing video and audio instructions to the patient on how to properly perform an exercise. When in operation, an avatar on the right side of the screen will extend his arms in a flexion motion from 0 degrees (i.e. his arms are at his side) to 180 degrees (i.e. his arms are straight above his head). Concurrently, a system computer generated voice may audibly instruct the patient on how to do the exercise, and how many repetitions to perform.

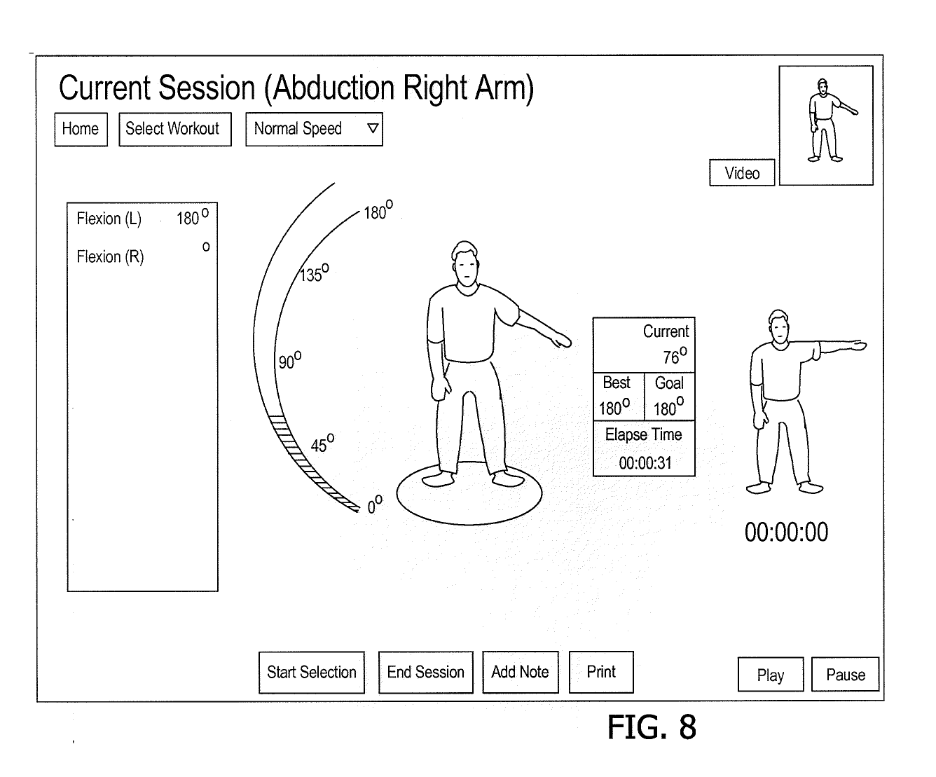

FIG. 8 displays the patient (middle image) actually following the movements as demonstrated by the avatar on the right side of the screen performing the exercise, while also displaying the live video of the patient (right upper corner of screen).

An example of an embodiment of the client-server architecture of the present disclosure is illustrated in FIG. 2. The client electronic computing device 132 in FIG. 2 comprises a clinician's electronic computing device for creating patients' account on the system server 160 or for reviewing a patient's history (recorded videos, dictated records, etc.). Once a patient's account is created, the clinician may select and store in the database of system server 160: standard exercise programs, patient-specific customized exercise programs, and written and/or audio/video materials. The clinician can also review the patient's exercise videos and provide audio, video, and/or written feedback and further instructions.

Additional client electronic computing devices also may comprise part of the system, wherein each device has modules or software loaded onto the device or accessible on the system server via the network. For example, a client computing device 142 may be located in a physical therapy clinic where a patient goes for prescribed rehabilitation treatments. A client computing device 144 may be used by a patient at home to access their medical records, videos and clinician communications on the system server, as well as to utilize it in connection with their own devices 120 and 140 to perform at home rehabilitation therapy and store a video of the session on the system server.

The Server System 160: The system server computer consists of one or more high speed CPU's (Central Processing Unit(s), primary memory (i.e. RAM) and secondary storage device(s) (i.e. hard disk drives). The computer-readable code of the present disclosure, the operating system and the database comprising clinicians' and patients' records are housed within the system server. The system server is coupled to the remote network 150 (such as the Internet), and can communicate and exchange information with a multiplicity of client computing devices (e.g. 130, 132, 140 and 144) simultaneously.

In one aspect, the present disclosure provides a computer program product comprising a computer useable medium and computer readable program code stored on the computer useable medium, which, when the computer readable program code is executed on a computer, performs a method for assisting a clinician in diagnosing or treating a musculoskeletal condition of a patient, the method comprising: capturing an image of a patient's movement of one or more musculoskeletal joints and appendages while the patient is performing a diagnostic or rehabilitation exercise; transmitting the image of the patient performing the exercise to a clinician; receiving the image of the patient performing the exercise; displaying the image of the patient performing the exercise; recording comments by a clinician on the patient's performance of the exercise; storing the image and comments in the patient's record in a database; and providing the patient access to the patient record.

In some embodiments, the computer program product further comprises computer readable program code stored on the computer useable medium, which, when the computer readable program code is executed on a computer, converts the imaging data into a range of motion in degrees of the musculoskeletal joints and appendages depicted in the image; and stores the range of motion data in the patient record. Additional features of the computer program product of the present disclosure are further described below.

Flowchart of Steps for Diagnostic and Rehabilitation Procedures

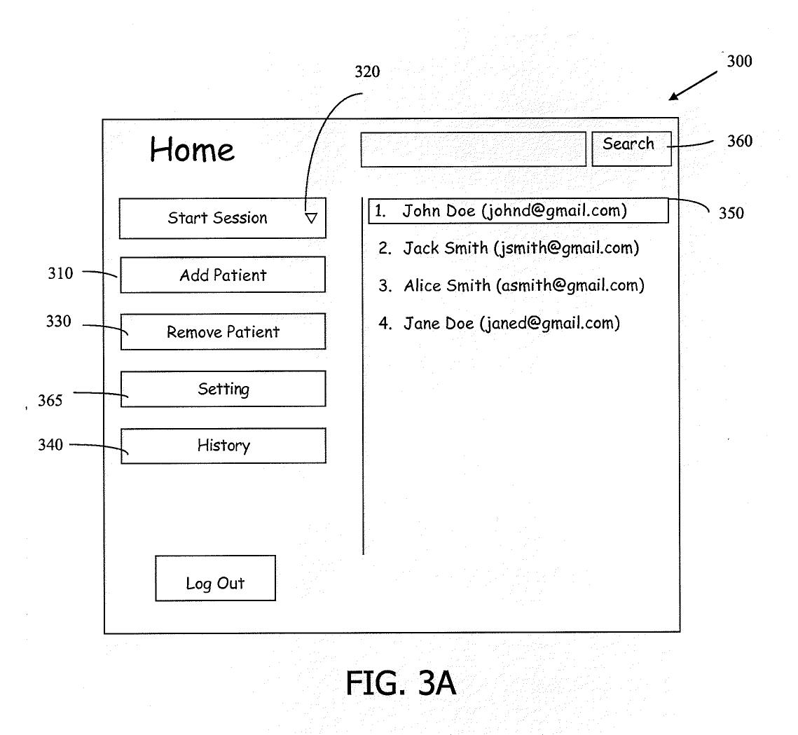

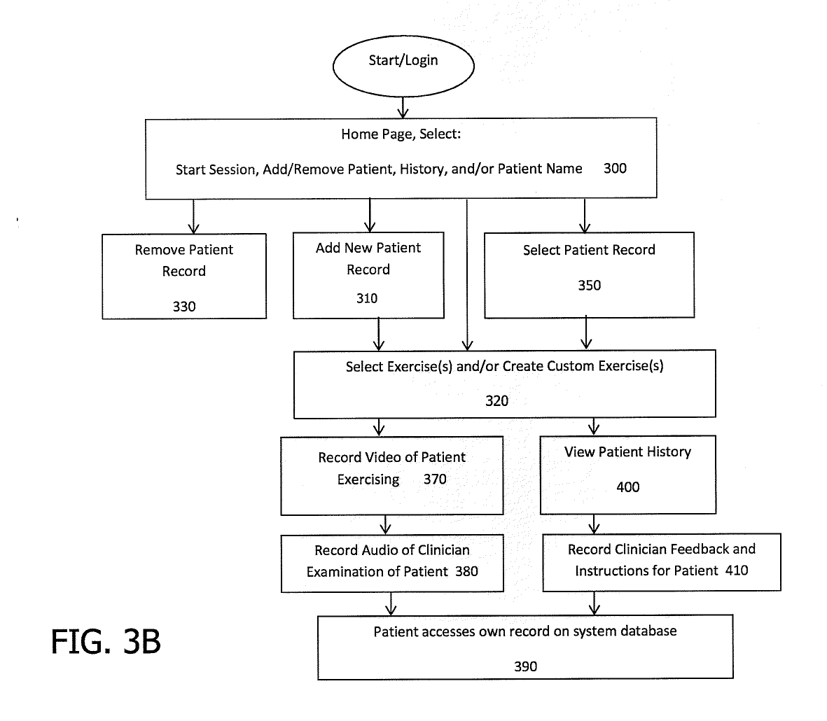

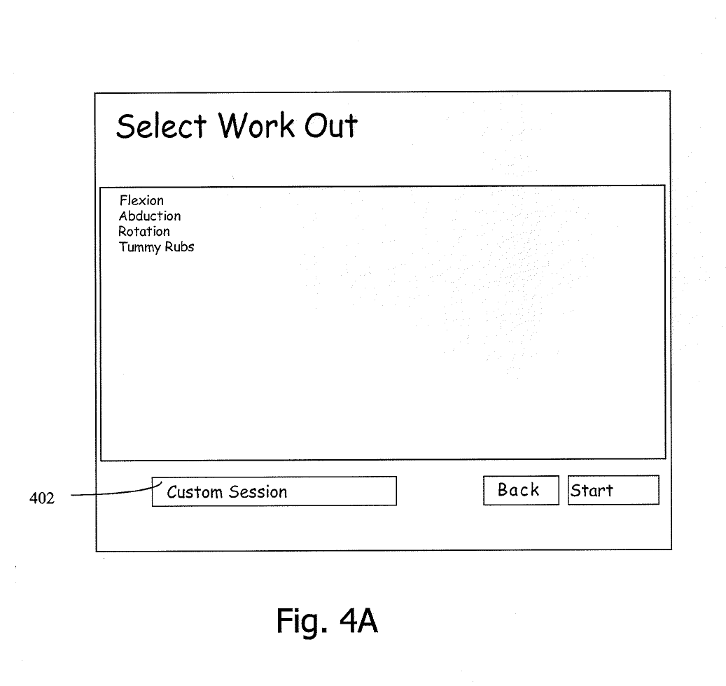

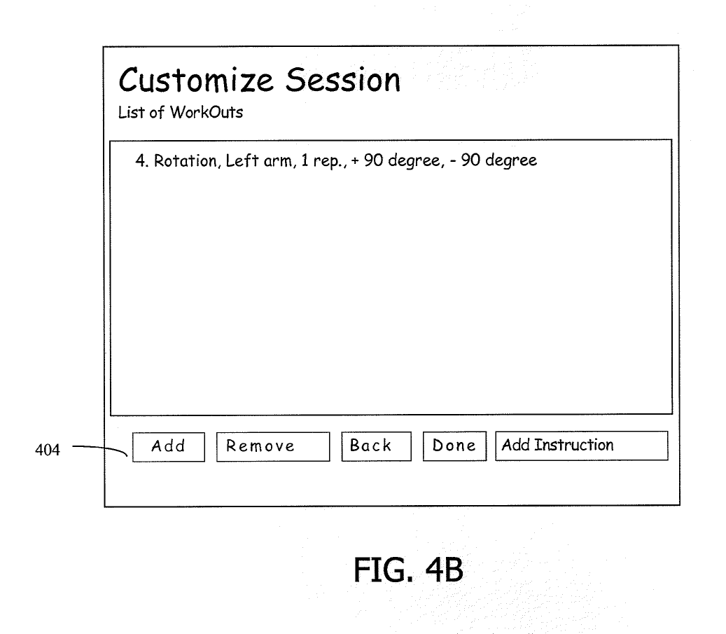

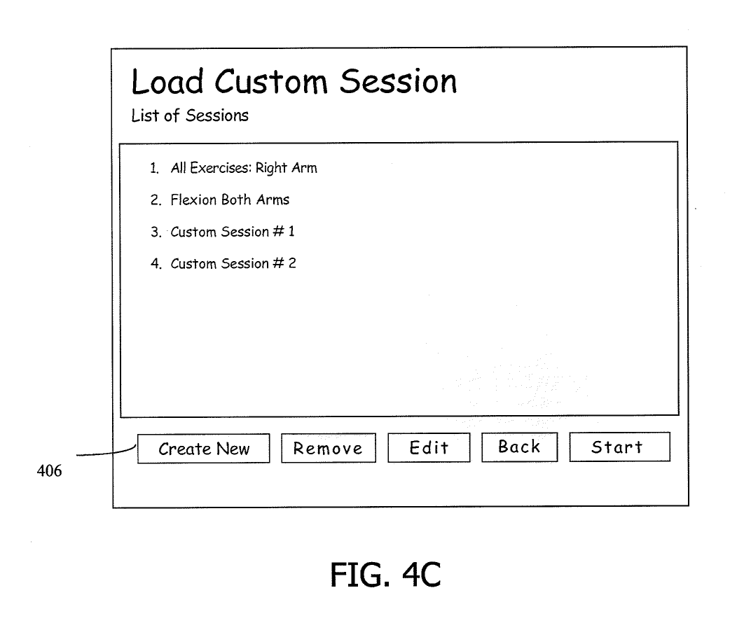

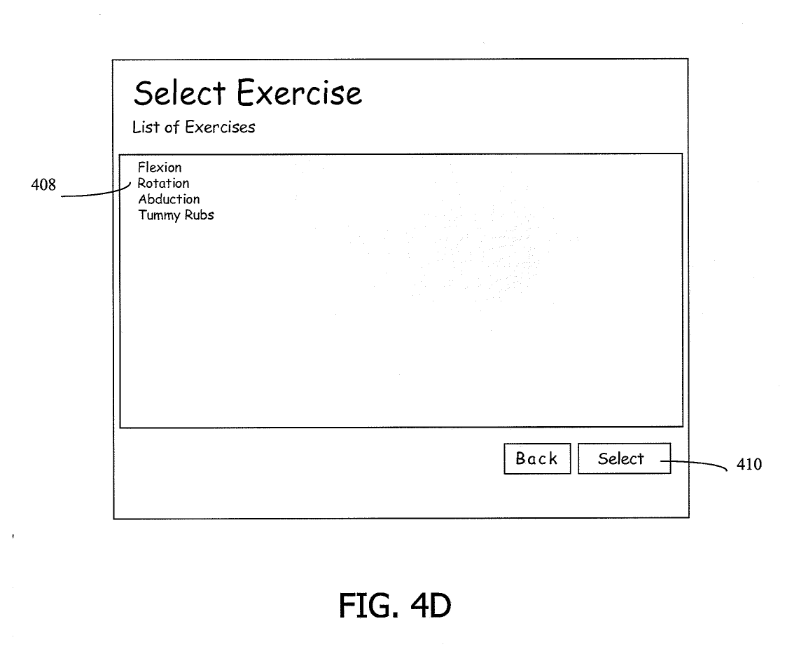

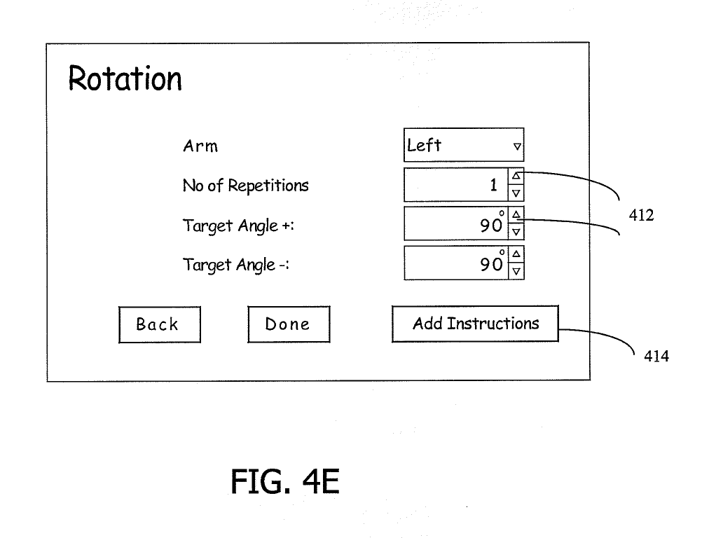

FIGS. 3A and 3B, and FIGS. 4A-4E illustrate the functions that can be performed by the computer-readable program code of the present disclosure. As shown in FIG. 3A, the clinician logs into their system server account using a secure login credentials (e.g. user name and password). The clinician is then presented on the homepage 300 with multiple options, comprising: Add Patient (310); Start Session with a drop down menu for the type of injury (i.e. anatomical location) (320); Remove Patient (330); History of a Patient (340), Selecting a Patient Record (350), a Search Feature (360), and Setting (365).

Creating Standard or Customized Routines

Using the computer-program product of the present disclosure, a clinician is able to create new standard diagnostic and treatment exercise routines for a patient with a disorder related to a specific musculoskeletal anatomical location (see tab 320 of the Homepage shown in FIG. 3A, and step 320 in the flowchart of FIG. 3B). Alternatively, computer program product of the present disclosure provides the clinician preprogrammed exercise routines that may be downloaded from the system server database.

For example, the clinician may create his own diagnostic exam avatar, or use an existing one for a shoulder disorder, for example, but not limited to, s/p rotator cuff repair; s/p shoulder instability repair; s/p subacromial decompression/biceps tenodesis; s/p capsular release; s/p total shoulder replacement; s/p reverse total shoulder; non operative impingement/strain; and, non-operative adhesive capsulitis.

To create a custom exercise (diagnostic or rehabilitative) for a particular disorder or for a particular patient, as an example, the clinician may follow the steps shown in FIG. 3A, and FIG. 4A-4E: select “Start Session” tab of the Homepage shown in FIG. 3A; in the “Select Workout” screen in FIG. 4A, select “Custom Session” tab 402; in the “Customize Session” screen in FIG. 4B, select exercise type “Add” tab 404 of FIG. 4B; in the “Load Customize Session” screen in FIG. 4C, select “Create New” tab 406; in the “Select Exercise” screen in FIG. 4D, select the exercise type in tab 408 and the “Select” tab 410; and in the exercise type screen (e.g. “Rotation” in FIG. 4E) use a drop down box 412 to indicate parameters of the exercise, such a number of repetitions, and the target angle for a given limb and exercise (e.g. for rotation of the shoulder, 90° to −90° or flexion/extension; for the knee 0° to 145°; etc.). At this point the clinician may also add voice instructions by selecting the “Add Instructions” tab 414 of FIG. 4E, and then by typing in text (screen not shown). The system will convert the written text into audio instructions that are played before the user starts to exercise. In the absence of customized instructions, the system will play default instructions.

Diagnostic Examination:

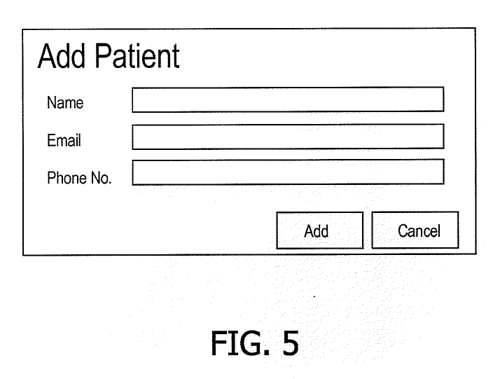

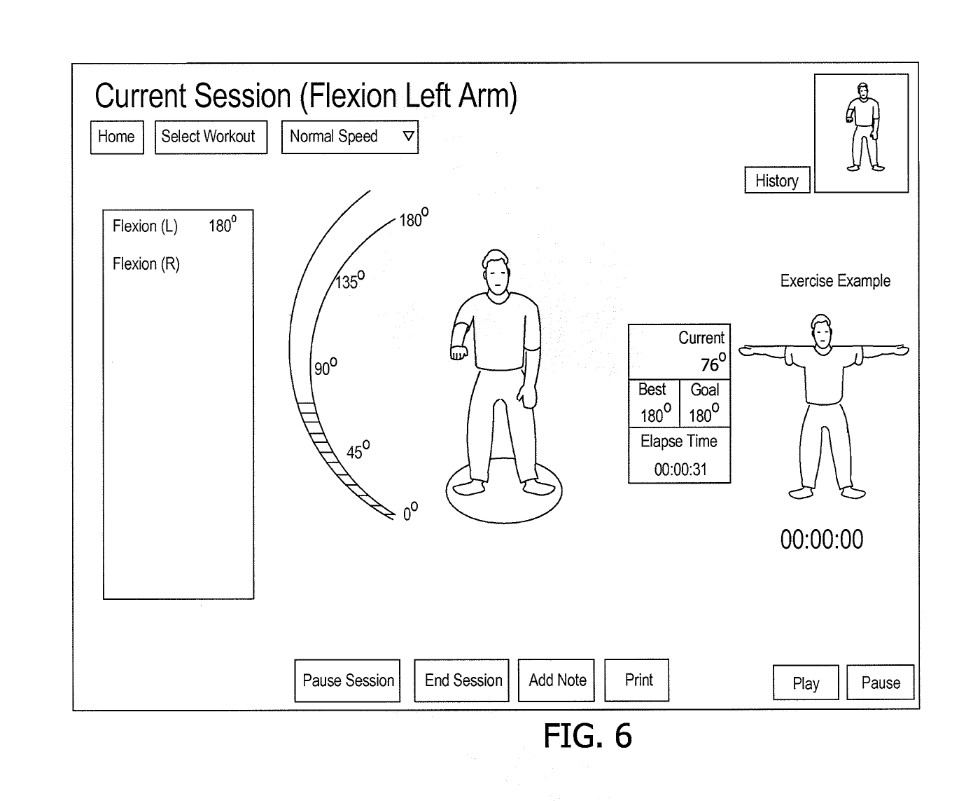

When the clinician selects “Add Patient” (310) tab on the home page (see FIG. 3A), he/she will be redirected to a screen as illustrated in FIG. 5 to enter the name, and the correspondence information of the patient (e.g. email address and telephone number), and then return to the homepage FIG. 3A. The clinician may then select “Start Session” in FIG. 3A, which comprises a drop down box 320 (shown in FIG. 3B) that permits the clinician to select a workout session for a particular type of musculoskeletal injury, disorder, and/or anatomical location, such as knee, elbow, shoulder, neck, low back, knee, hip, ankle; or a general exam (all body parts). For example, and as illustrated in FIG. 4A, to select a workout session for a shoulder disorder, from the “Select Workout” screen, the clinician may select a workout session comprising one or more of: flexion, rotation, abduction, or a custom session created by the clinician.

Demonstrating the Exercise: the computer program product of the present disclosure may demonstrate the exercise that the patient is to perform using an avatar, and an audio recording describing the proper movement (e.g. see FIG. 7, right avatar).

Recording Patient: The patient will then perform the exercise while being recorded by the system, and as illustrated in FIG. 8 (middle avatar) (and FIG. 3B, step 370). The avatar on the right will be guiding the patient (avatar in middle of screen) via demonstrating the proper movement and speed of movement, while the system plays an audio recording of instructions, e.g. counts for the number of repetitions the patient has completed. The actual camera image of the patient is seen in the upper right corner of the screen shown in FIG. 8.

Correcting the Patient: The system will also automatically correct the patient if they are in the wrong position for the system to properly record their movement, such as that they are rotated away from the camera, or are too far right or left of the camera. The system will also correct the patient if they are conducting the exercise too fast or slow for the set speed.

Audio Recording of Clinician's Exam: Following the patient's completion of the diagnostic exercises, the clinician will review the video and optionally, then perform a physical examination. During his/her examination, the clinician may orally state their findings while the system records their voices (see FIG. 3B, step 380).

Create Patient Record: The oral comments by the clinician during the physical examination may then be converted to written form within the patient's medical records. The comments may then be stored with the patient's file on the system server along with the video of the patient exercising.

Patient Accesses Record: The patient may be provided access to selected parts of their record on the system server in order to have a copy of the videos, clinicians' notes, and other medical information for their own use (see FIG. 3B, step 390). When the patient subsequently performs rehabilitation videos, either at home or in a physical therapy clinic, the videos may be stored within the patient file so that the patient may also access the videos and any notes the clinician has provided them for future treatment.

Exemplification of a Shoulder Diagnostic Examination:

The following is an exemplification for the using the system, method, and computer program product of the present disclosure to assist a clinician in diagnosing a patient's shoulder condition. In this example, the system is used to calculate the patient's range of motion of the afflicted shoulder, and then to record the clinician's verbally dictated examination notes made during the physical examination:

1) Simple Shoulder Exam—utilizing the system of FIGS. 1 and 2, the active range of motion of the patient's shoulder is video recorded. A medical assistant/nurse operates the computer and has the patient follow along. The patient can be given a print out of his/her current motion and a graphical representation of the change in her motion. This information can also be accessed (along with the actual avatar motion) on the Internet via a password protected secure website.

2) Completion of a level four physical exam for the shoulder by the clinician:
a) cervical/lumbar range of motion examination is recorded by the system;
b) finger to nose test is recorded by the system;
c) the system is used to record the verbal dictation of the clinician, e.g.:
   i) general—“The patient is well developed, pleasant, cooperative throughout the entire history and physical examination, appears stated age, is alert and oriented x3.”
   ii) vascular—“Radial and ulnar pulses are palpable and symmetrical. Good capillary refill. No significant swelling is appreciated.”
   iii) skin—“No scars, rashes or lesions are noted across bilateral upper extremities, head, face, neck or trunk.”
   iv) lymphatic—“No cervical or axillary lymphadenopathy is palpable.”
   v) “Patient ambulates with a normal gait.”
   vi) “Shoulder—strength, stability, inspection.”
   vii) “Spine—strength stability, inspection.”

At the completion of the exam, the patient is provided with a printed summary of the exam and recommendations. S/he is also able to access the exam and avatar at home via a website link to the stored patient record on the system server. A medical transcriptionist may then access the audio file of the exam and type in the clinician's oral dictation. In an alternative embodiment, the computer program product of the present disclosure comprises modules to automatically convert the clinician's oral dictation from the examination into written notes recorded in the patient's medical records.

Rehabilitation Exercise Routines:

In addition to using the system to assist a clinician in more efficiently and objectively diagnosing a patient's physical condition of a musculoskeletal injury, the system may also be used to instruct and record the patient conducting exercises for rehabilitation after being diagnosed and possibly undergoing surgery. The system would be used in a similar manner as outlined in FIG. 3B, steps 350 “Selecting a Patient Record”, step 320 “Selecting Exercises and/or Creating Custom Exercises”, and step 370 “Recording a Video of the Patient Exercising” and storing the video on the system database.

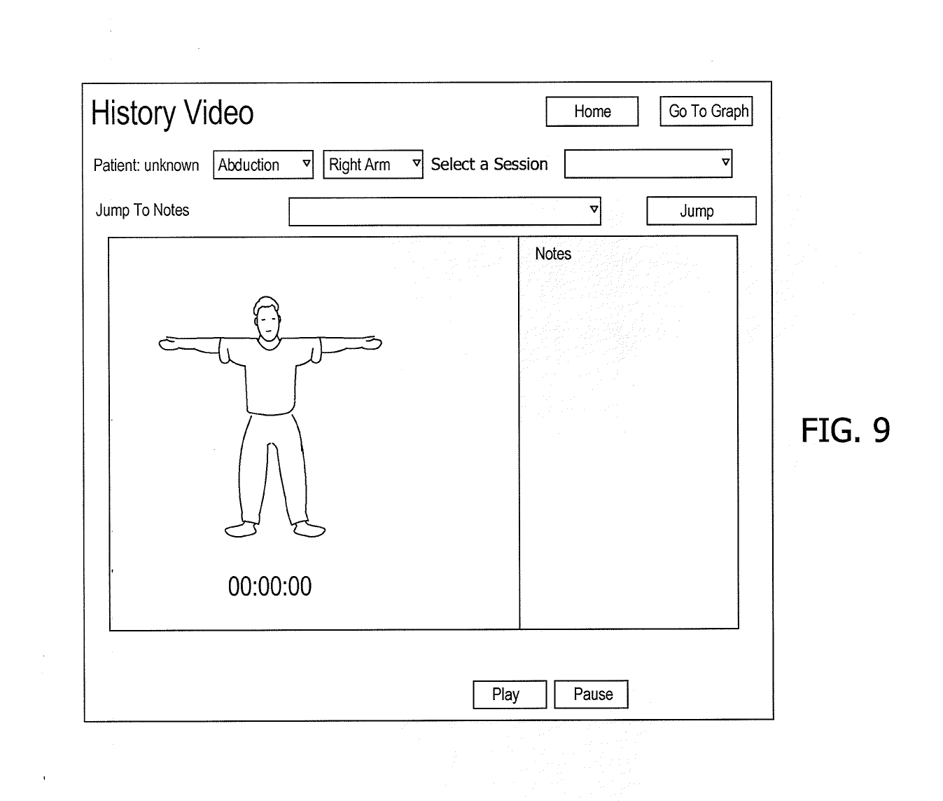

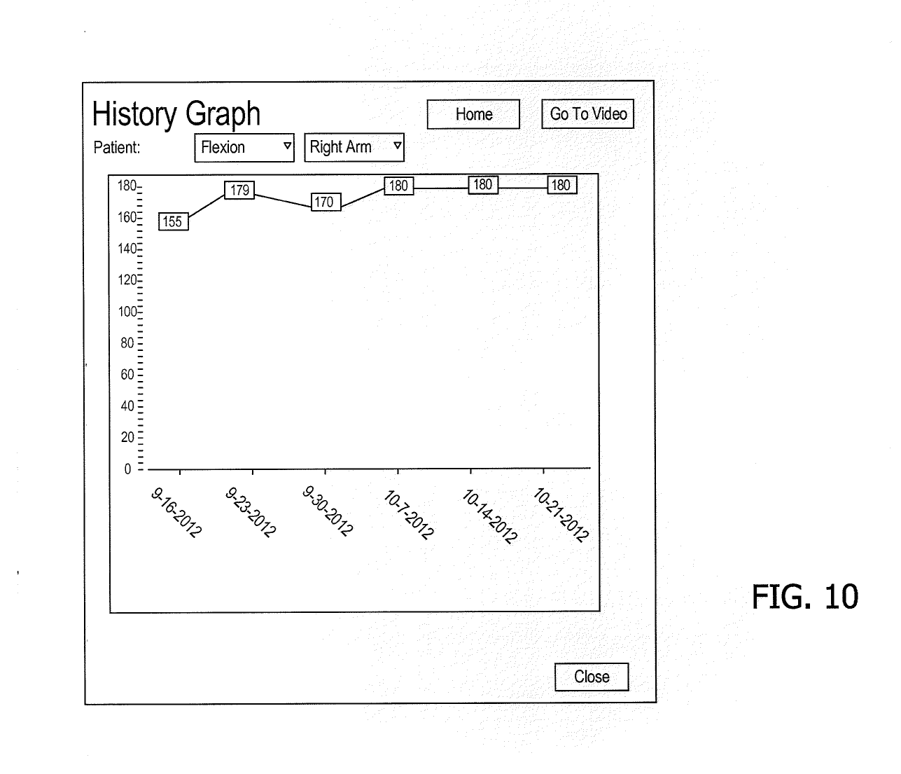

The clinician can subsequently review the video from his/her client computing device (e.g. FIG. 2, 132, FIG. 3B, step 400, and FIG. 9). As illustrated in FIG. 9, the clinician can select which exercise session s/he wishes to review, go to the graph (e.g. History Graph in FIG. 10), and type in notes—which are then added to the patient's record. The “Select a Session” tab in FIG. 9 enables the clinician to select from a drop down list of dates of recorded exercise sessions. The “Jump to Notes” tab in FIG. 9 enables the clinician to navigate to the notes documented on a given session.

The clinician, and the patient, may view the patient's rehabilitation progress on the system record (see FIG. 3B, steps 390, 400, and 410). The system generates a “History Graph”, as illustrated in FIG. 10, which comprises the dates of the recorded exercise session (x-axis) versus the range of motion achieved on that date (y-axis), and wherein the boxes on the lines of the graph note the maximum range of motion (e.g. flexion) achieved on that particular date.

While the description herein are focuses on diagnosing and treating shoulder conditions, the system, method, and computer program product of the present disclosure may be utilized for all musculoskeletal conditions, such as those pertaining to knees, hips, elbows, and ankles. The computer program product of the present disclosure may also be used in conjunction with workout machines (e.g. leg extension) comprising pressure sensors to measure and record a patient's strength in the afflicted area, as well as the range of motion.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the present disclosure. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the present disclosure.

It is to be understood that the phraseology and terminology employed herein is not to be construed as limiting and are for descriptive purpose only.

It is to be understood that the details set forth herein do not construe a limitation to an application of the present disclosure.

Furthermore, it is to be understood that the invention can be carried out or practiced in various ways and that the invention can be implemented in embodiments other than the ones outlined in the description above.

It is to be understood that the terms “including,” “comprising,” and grammatical variants thereof do not preclude the addition of one or more components, features, steps, or integers or groups thereof and that the terms are to be construed as specifying components, features, steps or integers.

While the invention has been illustrated and described, it will be appreciated that various changes can be made therein without departing from the spirit and scope of the invention.

I claim:

1. A method in a computer system for assisting a clinician in diagnosing or treating a musculoskeletal condition of a patient, the method comprising:
capturing an image of a patient's movement of one or more musculoskeletal joints and appendages while the patient is performing a diagnostic or rehabilitation exercise;
transmitting the image of the patient performing the exercise to a clinician;
receiving the image of the patient performing the exercise;
displaying the image of the patient performing the exercise;
recording comments by a clinician on the patient's performance of the exercise;
storing the image and comments in the patient's record in a database; and
providing the patient access to the patient record.

2. The method of claim 1, further comprising converting the imaging data into a range of motion in degrees of the musculoskeletal joints and appendages depicted in the image;
and storing the range of motion data in the patient record.

3. The method of claim 1, further comprising recording the clinician's comments during an in-person examination of the patient; and storing the clinician's comments in the patient record.

4. The method of claim 1, further comprising projecting on a screen a computer-generated human image to illustrate performance of the exercise.

5. The method of claim 1, further comprising providing audio instructions on how to perform the exercise.

6. The method of claim 1, wherein the rehabilitation exercise is a standard exercise or a patient-specific custom exercise.

7. A method in a computer system for assisting a clinician in diagnosing or treating a musculoskeletal condition of a patient, the method comprising:
receiving, over a communication network from a computing device, a transmission of an image of a patient's movement of one or more musculoskeletal joints and appendages;
displaying the image of the patient performing the exercise;
recording comments by a clinician on the image of the patient's movement;
storing the image and comments in the patient's record in a database; and
providing the patient access to the patient record.

8. A computer system for assisting a clinician in diagnosing or treating a musculoskeletal condition of a patient, comprising:
an imaging component that captures an image of a patient's movement of one or more musculoskeletal joints and appendages;
a transmission component that transmits the image to a clinician;
a receiving component that receives the image;
a display component that displays the image;
a recording component that records the clinician's verbal comments regarding the image; and
a storage component that stores the image and comments in a patient record.

9. The computer system of claim 9, further comprising a conversion component that converts the imaging data into a range of motion in degrees of the musculoskeletal joints and appendages depicted in the image.

10. A computer program product comprising a computer useable medium and computer readable program code stored on the computer useable medium, which, when the computer readable program code is executed on a computer, performs a method for assisting a clinician in diagnosing or treating a musculoskeletal condition of a patient, the method comprising:
capturing an image of a patient's movement of one or more musculoskeletal joints and appendages while the patient is performing a diagnostic or rehabilitation exercise;
transmitting the image of the patient performing the exercise to a clinician;
receiving the image of the patient performing the exercise;
displaying the image of the patient performing the exercise;
recording comments by a clinician on the patient's performance of the exercise;
storing the image and comments in the patient's record in a database; and
providing the patient access to the patient record.

11. The method performed by the computer program product of claim 11, further comprising converting the imaging data into a range of motion in degrees of the musculoskeletal joints and appendages depicted in the image; and storing the range of motion data in the patient record.
